(19) United States
(12) Patent Application Publication
(10) Pub. No.: US 2007/0004894 A1
(43) Pub. Date: Jan. 4, 2007

(54) Silicon-free polyisocyanate or polyurethanes having monoamide-containing hydrophilic groups

(75) Inventors: Jan Mazanek, Koln (DE); Sebastian Dorr, Dusseldorf (DE); Olaf Fleck, Bergisch Gladbach (DE); Heino Muller, Leverkusen (DE); Harald Blum, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/475,414

(22) Filed: Jun. 27, 2006

(30) Foreign Application Priority Data
Jun. 30, 2005 (DE) 102005030523.7

(51) Int. Cl. C08G 18/00

(52) U.S. Cl. 528/44

(57) ABSTRACT

The present invention relates to silicon-free polyisocyanates or polyurethanes which contain at least one structural unit of formula (1) 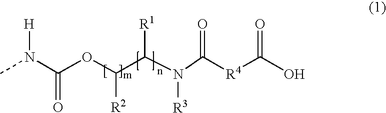 wherein m is 0 to 8, n is 0 to 8, m+n is≧2,
R¹ and R² independently of one another are each hydrogen or an OH-free, optionally substituted C₁ to C₈ alkyl or cycloalkyl radical,
R⁴ is the radical obtained by removing the carboxylic acid groups from a difunctional aliphatic dicarboxylic acid having at least two carbon atoms, a cycloaliphatic dicarboxylic acid having at least 6 carbon atoms or an aromatic dicarboxylic acid having at least 6 carbon atoms, and
R³ is the same as R¹ or R² or corresponds to formula (2) 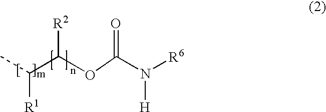 wherein
   R¹ and R² are as defined above and
   R⁶ is an alkyl or aryl radical obtained by removing an isocyanate group from a di- or polyisocyanate having optionally blocked NCO groups. The present invention also relates to a process for preparing these silicon-free polyisocyanates or polyurethanes.

### BACKGROUND OF THE INVENTION

1. Field of the Invention

The present invention relates to silicon-free polyisocyanates or polyurethanes having monoamide-containing hydrophilic groups, to their preparation and to aqueous and/or water-dilutable dispersions containing these polyisocyanates or polyurethanes.

2. Description of Related Art

Hydrophilic agents are used in the preparation of solutions and/or dispersions of poly-urethanes in order to be able to transfer the polymers to the aqueous phase following their synthesis, and/or in order to stabilize the solutions and/or dispersions against sedimentation. Known hydrophilic agents include various cationic, anionic and/or nonionic compounds, such as mono- and/or dihydroxy carboxylic acids or monofunctional alkyl ethoxylates, which are also employed in mixtures with one another.

One of the important considerations when selecting appropriate hydrophilic agents is their availability or ease of preparation. Hydroxyl-containing alkylamide carboxylic acids, which are easily prepared from alkylamines and carboxylic anhydrides, for example, have to date been used only occasionally in the preparation of dispersions.

U.S. Pat. Nos. 6,641,922 and 6,613,859 describe water-dilutable products prepared by reacting the reaction product of diethanolamine and phthalic anhydride with tolylene diisocyanate and a silicone resin, with subsequent neutralization.

The publication of Tang, Jialing et al. (Zhangguo Pige (1998), 27 (7), 15-17) describes polyurethane dispersions which have been rendered hydrophilic with the bis-hydroxyethyl monoamide of phthalic acid. The publication of Lin, Jianhong et al.

(Gaofenzi Xuebao (2001) (1) 127-129) describes studies on polyurethane dispersions rendered hydrophilic, in the course of their preparation, with bis-hydroxyethyl monoamides of phthalic acid.

None of the prior art studies of the prior art describes the use of these monoamides in the preparation of blocked polyisocyanates for use in aqueous baking systems. It has now been found that the hydroxy-functional amides of at least difunctional carboxylic acids are highly suitable for hydrophilic polyisocyanates or polyurethanes. The polyurethanes or polyisocyanates rendered hydrophilic in accordance with the invention contain blocked NCO groups and hydrophilic groups, and are especially suitable for preparing self-crosslinking aqueous baking coating compositions.

### SUMMARY OF THE INVENTION

The present invention relates to silicon-free polyisocyanates or polyurethanes which contain at least one structural unit of formula (1) 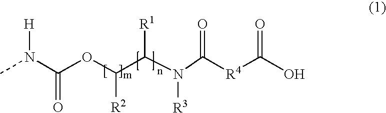
wherein
m is 0 to 8,
n is 0to 8,
m+n is≧2,
R¹ and R² independently of one another are each hydrogen or an OH-free, optionally substituted C₁ to C₈ alkyl or cycloalkyl radical,
R⁴ is the radical obtained by removing the carboxylic acid groups from a difunctional aliphatic dicarboxylic acid having at least two carbon atoms, a cycloaliphatic dicarboxylic acid having at least 6 carbon atoms or an aromatic dicarboxylic acid having at least 6 carbon atoms, and
R³ is the same as R¹ or R² or corresponds to formula (2) 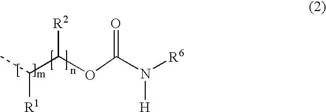
   wherein
   R¹ and R² are as defined above and
   R⁶ is an alkyl or aryl radical obtained by removing an isocyanate group from a di- or polyisocyanate having optionally blocked NCO groups.

The present invention also relates to a process for preparing these silicon-free polyisocyanates or polyurethanes by reacting
A) polyisocyanates with
B) monoamides of formula (3) 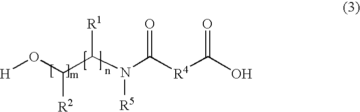
   wherein
   m is0to 8,
   n is0to 8,
   m+n is≧2,
   R¹ and R² independently of one another are each hydrogen or an OH-free, C₁ to C₈ alkyl or cycloalkyl radical,
   R⁴ is the radical obtained by removing the carboxylic acid groups from a difunctional aliphatic dicarboxylic acid having at least two carbon atoms, a cycloaliphatic dicarboxylic acid having at least 6 carbon atoms or an aromatic dicarboxylic acid having at least 6 carbon atoms, and
   R⁵ is the same as R¹ or R² or corresponds to formula (6) 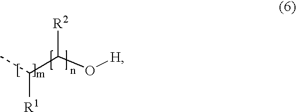
C) polyols and
D) optionally other compounds containing isocyanate-reactive groups.

### DETAILED DESCRIPTION OF THE INVENTION

Suitable polyisocyanates A) include the NCO group-containing compounds known from polyurethane chemistry preferably having a functionality of 2 or more. Examples include aliphatic, cycloaliphatic, araliphatic and/or aromatic di- or triisocyanates and also their higher molecular weight adducts containing urethane, allophanate, biuret, uretdione and/or isocyanurate groups and having two or more free NCO groups.

Preferred di- or triisocyanates include tetramethylene diisocyanate, cyclohexane 1,3- and 1,4-diisocyanate, hexamethylene diisocyanate (HDI), 1-isocyanato-3,3,5-trimethyl-5-isocyanato-methylcyclohexane (isophorone diisocyanate, IPDI), methylenebis(4-isocyanatocyclohexane), tetramethylxylylene diisocyanate (TMXDI), triisocyanatononane, tolylene diisocyanate (TDI), diphenylmethane 2,4′- and/or 4,4′-diisocyanate (MDI), triphenylmethane-4,4′-diisocyanate, naphthylene 1,5-diisocyanate, and mixtures thereof.

These polyisocyanates preferably have isocyanate contents of 0.5 to 50% by weight, more preferably 3 to 30% by weight, most preferably 5 to 25% by weight.

Preferred polyisocyanates A) for preparing the polyisocyanates or polyurethanes of the invention are those prepared from aliphatic and/or cycloaliphatic polyisocyanates, more preferably HDI and/or IPDI. More preferred polyisocyanates A) are the polyisocyanate adducts containing biuret, isocyanurate and/or uretdione groups, especially those prepared from hexamethylene diisocyanate or isophorone diisocyanate.

Suitable monoamides B) are obtained by reacting hydroxylamines having one or two free OH groups and one primary or secondary amino group with compounds which contain at least two carboxylic acid groups or at least one anhydride group per molecule. For each equivalent of free COOH and COO groups it is preferred to use 0.5 equivalent of the hydroxylamine, or one equivalent of the hydroxylamine for each anhydride function.

Preferred are difunctional carboxylic acids and their anhydrides, and more preferably their anhydrides.

These anhydrides preferably correspond to formula (4) 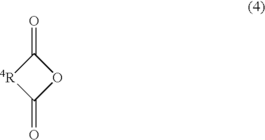
wherein
R⁴ is the radical obtained by removing the carboxylic acid groups from a difunctional aliphatic dicarboxylic acid having at least 2 carbon atoms, a cycloaliphatic dicarboxylic acid having at least 6 carbon atoms or sn aromatic dicarboxylic acid having at least 6 carbon atoms.

Preferred anhydrides of formula (4) are phthalic, succinic, trimellitic, hexa- and tetrahydrophthalic and maleic anhydride. Particularly preferred anhydrides are phthalic, trimellitic and hexahydrophthalic anhydride.

The hydroxylamines correspond to formula (5) 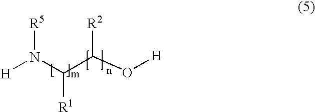
wherein
m and n are integers between 0 and 8 and
m+n is a number greater than or equal to 2, and
R¹ and R² independently of one another are each hydrogen or an OH-free, optionally substituted C₁ to C₈ alkyl or cycloalkyl radical,
R⁵ corresponds to R¹ or R² or corresponds to formula (6) 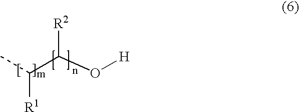
   wherein
   R¹ and R² are as defined above.

In the preceding formulas when R¹ or R² represent C₁ to C₈ alkyl or cycloalkyl radicals, they may be optionally substituted, provided that the substituents do not interfere with the reaction to form the hydroxylamines of formula (5) or the reaction to the form the polyisocyanates or polyurethanes according to the invention.

Preferred hydroxylamines are those of the formula (5) wherein R⁵ corresponds to the definition of R¹ or R², such that the hydroxylamine is monohydroxy-functional.

Particularly preferred hydroxylamines are 1-aminopropanol, or alkylethanolamines or alkylisopropanolamines having 1 to 5 carbon atoms in the alkyl radical. Especially preferred are N-methylethanolamine, N-methylisopropanolamine or 1 -aminopropanol.

These OH- and COOH-containing monoamides are prepared in conventional manner by reacting carboxylic acid groups or carboxylic anhydride with the hydroxylamine at, for example, temperatures of 10 to 80° C., preferably of 25 to 60° C., preferably in solvents such as N-methylpyrrolidone, acetone, methyl ethyl ketone or methoxypropyl acetate.

Suitable polyols C) include relatively high molecular weight polyester, polyesteramide, polyurethane, polyacrylate, polycarbonate, polyacetal and polyether polyols having number average molecular weights of at least 500 g/mol, preferably 500 to 8000 g/mol and more preferably 800 to 5000 g/mol.

Suitable polyester polyols include linear polyester diols or branched polyester polyols prepared in known manner from aliphatic, cycloaliphatic or aromatic di- or polycarboxylic acids or their anhydrides, such as succinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic or trimellitic acid and also acid anhydrides such as o-phthalic, trimellitic or succinic anhydride, or mixtures thereof, with polyhydric alcohols such as ethanediol, di-, tri-, tetraethylene glycol, 1,2-propanediol, di-, tri-, tetrapropylene glycol, 1,3-propanediol, butane-1,4-diol, butane-1,3-diol, butane-2,3-diol, pentane-1,5-diol, hexane-1,6-diol, 2,2-dimethyl-1,3-propanediol,

1,4-dihydroxycyclohexane, 1,4-dimethylolcyclohexane, octane-1,8-diol, decane-1,10-diol, dodecane-1,12-diol or mixtures thereof, with or without the accompanying use of polyols of higher functionality, such as trimethylolpropane or glycerol. Suitable polyhydric alcohols for preparing the polyester polyols include cycloaliphatic and/or aromatic di- and polyhydroxyl compounds. Instead of the free polycarboxylic acids it is also possible to use the corresponding polycarboxylic anhydrides or corresponding polycarboxylic esters of lower alcohols, or mixtures thereof, to prepare the polyesters.

The polyester polyols also include homopolymers or copolymers of lactones, obtained preferably by subjecting lactones or lactone mixtures, such as butyrolactone, ε-caprolactone and/or methyl-ε-caprolactone, to an addition reaction with suitable starter molecules having a functionality of two and/or more, such as the low molecular weight, polyhydric alcohols previously disclosed as synthesis components for polyester polyols. The corresponding polymers of ε-caprolactone are particularly preferred.

Suitable polycarbonate polyols are those prepared by reacting diols such as 1,4-butanediol and/or 1,6-hexanediol with phosgene or diaryl carbonates such as diphenyl carbonate.

Suitable polyether polyols include the polyaddition products of styrene oxides, ethylene oxide, propylene oxide, tetrahydrofuran, butylene oxide, epichlorohydrin, and also their coadducts and grafting products, the polyether polyols obtained by condensing polyhydric alcohols or mixtures thereof, and the polyether polyols obtained by alkoxylating polyhydric alcohols, amines and amino alcohols.

Polyols C) also include the low molecular weight polyhydroxyl compounds, preferably diols, having a molecular weight of 62 to 499 g/mol. Examples include the polyhydric alcohols, especially dihydric alcohols, previously disclosed for the preparation of the polyester polyols, and, additionally, low molecular weight polyester diols such as bis(hydroxyethyl) adipate, or short-chain homoadducts and coadducts of ethylene oxide or propylene oxide that are prepared starting from aromatic diols. Examples of aromatic diols which may be used as starters for the short chain homopolymers and copolymers of ethylene oxide or of propylene oxide include 1,4-, 1,3-, 1,2-dihydroxybenzene or 2,2-bis(4-hydroxyphenyl)propane (bisphenol A).

Suitable isocyanate-reactive compounds D) include the blocking agents known from polyurethane chemistry. Examples include ε-caprolactam, diethyl malonate, ethyl acetoacetate, oximes such as butanone oxime, amines such as N-tert-butylbenzylamine or diisopropylamine, dimethylpyrazole, triazole or mixtures thereof.

Also suitability as component D) are hydrophilic agents other than those of component B). As hydrophilic agents it is possible in D) to use the cationic, anionic and/or nonionic compounds known from polyurethane chemistry, such as mono- and/or dihydroxy carboxylic acids or monofunctional alkyl ethoxylates. It is also possible to employ mixtures of different hydrophilic agents.

In one preferred embodiment A) is first reacted with B) such that there are still free NCO groups in the reaction product. The NCO/OH equivalent ratio is preferably 20:1 to 1.5:1, more preferably 15:1 to 2:1. Subsequently, the hydrophilic, NCO-containing polymer is reacted with polyols C) in an amount sufficient to provide an OH-functional polymer free from NCO groups. On exposure to heat, these polymers are able to undergo deblocking, and to crosslink with free OH groups. These polymers can also be used, however, as an OH component which is crosslinked with other polyisocyanates containing blocked or free NCO groups.

In the process of the invention it is additionally possible to use the catalysts, additives, and solvents that are known from polyurethane chemistry. If catalysts are used they are used in amounts of 0.01 to 5% by weight, preferably 0.05 to 4% by weight, and more preferably 0.07 to 1.5% by weight.

The present invention also relates to dispersions containing the polyurethanes of the invention. Aqueous dispersions can be prepared from the silicon-free blocked polyisocyanates and/or polyurethanes of the invention by neutralizing some or all of the free carboxyl groups by adding base, before, during or after the polyisocyanates are mixed with water. Neutralizing can be carried out using, for example, any desired amines, such as triethylamine, dimethylcyclohexylamine, methyl- and ethyl-diisopropylamine or dimethylethanolamine. Ammonia is also suitable. Triethylamine, ethyldiisopropylamine and dimethylethanolamine are preferred for neutralization. Neutralization preferably takes place between room temperature and 110° C. The molar amount of the bases is generally between 50% and 150%, preferably between 60% and 100% of the molar amount of the anionic groups. The resulting dispersions have a solids content of 20% to 70%, preferably 25% to 50%.

The polyurethanes of the invention can be employed as self-crosslinking polymers or also, in combination with polyols and further additives known from coatings technology, for preparing coating compositions, adhesives and elastomers.

The present invention also relates to coating compositions containing the polyurethanes of the invention and optionally polyols. Suitable polyols are the relatively high molecular weight compounds previously disclosed, e.g., the polyester, polyesteramide, polyurethane, polyacrylate, polycarbonate, polyacetal and polyether polyols having number average molecular weights of at least 500 g/mol, preferably 500 to 8000 g/mol and more preferably 800 to 5000 g/mol.

These coating compositions are suitable for coating substrates, preferably metals, minerals, wood and plastics, e.g. for industrial coating, for coating textiles, and in automotive OEM finishing. For these purposes the coating compositions can be applied by knife coating, dipping, spray applications such as compressed-air spraying or airless spraying, and by electrostatic application, such as the high-speed rotating bell application. The dry film thickness is, for example, 10-120 μm. The dried films are cured by baking at a temperature from 90 to 160° C., preferably 110 to 140° C. and more preferably 120 to 130° C..

The varnishes, paints and other formulations are prepared from the polyisocyanates and/or polyurethanes of the invention by known methods. In addition to the polyisocyanates and optionally polyols, the formulations may also contain known additives, such as pigments, fillers, flow control agents, defoamers, dispersing assistants and catalysts, in amounts that are known or readily determined.

The invention is further illustrated but is not intended to be limited by the following examples in which all parts and percentages are by weight unless otherwise specified.

### EXAMPLES

The reported viscosities were determined by rotational viscometry in accordance with DIN 53019, using a rotational viscometer from Anton Paar Germany GmbH, Ostfildern, DE.

Unless expressly stated otherwise, NCO contents were determined volumetrically in accordance with DIN-EN ISO 11909. STOP

The reported particle sizes were determined by means of laser correlation spectroscopy (instrument: Malvern Zetasizer 1000, Malvern Instr. Limited).

Checking for free NCO groups was carried out by IR spectroscopy (band at 2260 cm⁻¹).

Desmodur® N 3300: Isocyanurate based on hexamethylenediisocyanate, Bayer MaterialScience AG, Leverkusen, DE

Desmophen® D 270: Hydroxyl-containing polyester, Bayer MateriaIScience AG, Leverkusen, DE

Additol XW 395: Flow control assistant/defoamer, UCB Chemicals, St. Louis, USA

Surfynol 104: Flow control assistant/defoamer, 50% in NMP, Air Products, Hattingen, DE

### Example 1

117.67 g (1.2 mol) of maleic anhydride were dissolved in 207.80 g of N-methylpyrroli-done. Over the course of 40 minutes, beginning at room temperature but with vigorous cooling, 90.13 g (1.2 mol) of 2-methylaminoethanol were added at a rate such that the temperature did not exceed 50° C. Stirring was continued at 50° C. until carboxylic anhydride groups were no longer detected by IR spectroscopy (approximately 60 minutes). Cooling to room temperature gave a clear solution having a solids content of 50%.

### Example 2

296.2 g (2 mol) of phthalic anhydride were mixed with 446.42 g of acetone and the mixture was heated to 60° C. and stirred until a clear solution was formed (approximately 1 hour). Then, over the course of 60 minutes and with stirring, at 60° C., 150.22 g (2 mol) of 2-methylaminoethanol were added and the mixture was subsequently stirred at 55° C. until carboxylic anhydride groups were no longer detected by IR spectroscopy (approximately 75 minutes). Thereafter 223.21 g of acetone and 50 g of N-methylpyrrolidone were added and the reaction mixture was cooled to room temperature. This gave a clear solution having a solids content of 38.28%.

### Example 3

308.34 g (2 mol) of bis-hexahydrophthalic anhydride were dissolved in 458.56 g of acetone. 150.22 g (2 mol) of 2-methylaminoethanol were added dropwise with stirring and cooling at 30° C. over the course of 60 minutes. Stirring was then continued at 40° C. until carboxylic anhydride groups were no longer detected by IR spectroscopy (approximately 2 hours). Cooling to room temperature gave a clear, 50% strength solution.

### Example 4

343.20 g (1.76 eq NCO) of Desmodur® N 3300 were admixed with 9.45 g (0.16 eq OH) of 1,6-hexanediol and the reaction mixture was stirred at 70° C. until after approximately 5 h an NCO content of 19.05% was reached. The mixture was then cooled to 30° C. and 220.11 g (0.48 eq OH) of the compound from Example 3 was added with cooling at 30° C. over the course of 20 minutes. Thereafter 1017.9 g of acetone were added and the reaction mixture was stirred further at 30° C. for 1 hour until an NCO content of 2.78% was reached. Thereafter 97.57 g (1.12 mol) of butanone oxime were added at 30° C. over the course of 10 minutes, and the mixture was cooled to room temperature and stirred for 30 minutes more. Thereafter NCO groups were no longer detected by IR spectroscopy.

The acid number of the reaction mixture was 15.73 mg KOH/g. Subsequently, with stirring at room temperature, 47.07 g (0.528 mol) of dimethylethanolamine were added, followed by stirring for 10 minutes and the addition of 1127.9 g of deionized water over the course of 15 minutes. Acetone was then distilled off under vacuum, lastly for an hour at 120 bar and 40° C. Cooling to room temperature and subsequently stirring for 4 hours gave a dispersion having the following properties:

| | | |
|---|---|---|
| Solids content | 32.2% | |
| pH | 9.18 | |
| Viscosity @ 23° C. | 400 | mPas |
| Particle size | 41 | nm |

### Example 5

343.20 g (1.76 eq NCO) of Desmodur® N 3300 were mixed with 9.45 g (0.16 eq OH) of 1,6-hexanediol and the reaction mixture was stirred at 70° C. until after approximately 5 h an NCO content of 19.03% was reached. Then 334.60 g of acetone and 223.21 g (0.40 eq OH) of the compound from Example 2 were added at 50° C. and the reaction mixture was stirred at 50° C. until an NCO content of 4.9% was reached. The mixture was then diluted with 787.9 g of acetone and cooled to 30° C., 93.55 g (1.072 mol) of butanone oxime were added over the course of 20 minutes, and stirring was continued for 50 minutes. Thereafter NCO groups were no longer detected by IR spectroscopy. After the mixture had been cooled to room temperature, 39.22 g (0.44 mol) of dimethylethanolamine were added over the course of 10 minutes, followed by stirring for 10 minutes and then mixing with 1067.3 g of deionized water. Acetone was subsequently distilled off under vacuum for 1 hour at 40° C./120 mbar. Thereafter the mixture was cooled to room temperature with stirring and stirred for 4 hours. The dispersion obtained possessed the following properties:

| | | |
|---|---|---|
| Solids content | 32.4% | |
| pH | 9.21 | |
| Viscosity @ 23° C. | 14 700 | mPas |
| Particle size | 45 | nm |

### Example 6

343.20 g (1.76 eq NCO) of Desmodur® N 3300 were mixed with 9.45 g (0.16 eq OH) of 1,6-hexanediol and the mixture was stirred at 70° C. until an NCO content of 19.03% was reached. Then 69.70 g (0.8 mol) of butanone oxime were added over the course of 30 minutes and the mixture was subsequently diluted with 552.54 g of acetone and cooled to 35° C. 83.12 g (0.24 eq OH) of the compound from Example 1 were added, and stirring was continued until after 3 h an NCO content of 1.58% was reached. Thereafter 34.85 g (0.4 mol) of butanone oxime were added over the course of 10 minutes and the mixture was stirred subsequently for 30 minutes until NCO groups were no longer detected by IR spectroscopy. Subsequently 584.82 g of acetone and 23.53 g (0.264 mol) of dimethylethanolamine were added at room temperature, the mixture was stirred for 10 minutes, and then 776.8 g of room temperature deionized water were added. Acetone was then distilled off under vacuum. The dispersion was subsequently cooled to room temperature and stirred for 4 hours more. It possessed the following properties:

| | | |
|---|---|---|
| Solids content | 27.5% | |
| pH | 8.83 | |
| Viscosity @ 23° C. | 480 | mPas |
| Particle size | 131 | nm |

### Example 7

The procedure of Example 4 was repeated, except that the compound from Example 3 was introduced initially with 1,6-hexanediol, after which Desmodur® N 3300 was added. Subsequently the mixture was stirred further at 35° C. until an NCO content of 2.91% was reached. The dispersion possessed the following properties:

| | | |
|---|---|---|
| Solids content | 32.6% | |
| pH | 9.26 | |
| Viscosity @ 23° C. | 7250 | mPas |
| Particle size | 74 | nm |

### Example 8

The procedure of Example 7 was repeated, except that the mixture of compound 3, 1,6-hexanediol and Desmodur® N 3300 was stirred until an NCO content of 2.65% was reached. The dispersion possessed the following properties:

| | | |
|---|---|---|
| Solids content | 32.0% | |
| pH | 9.28 | |
| Viscosity @ 23° C. | 300 | mPas |
| Particle size | 27 | nm |

### Example 9

The procedure described in Example 5, except that 139.93 g (0.24 eq OH) of compound from Example 2, 110.12 (1.264 mol) of butanone oxime and 14.71 g (0.264 mol) of dimethylethanolamine were used. The dispersion obtained possessed the following properties:

| | | |
|---|---|---|
| Solids content | 30.0% | |
| pH | 8.89 | |
| Viscosity @ 23° C. | < 50 | mPas |
| Particle size | 55 | nm |

### Example 10

The procedure described in Example 9 was repeated, except that in addition to the compound from Example 2, 16.00 g (0.032 eq OH) of a polyethylene oxide having a number average molecular weight of 500 and prepared starting from methanol were used, and only 108.73 g (1.248 eq) of butanone oxime were used. The dispersion possessed the following properties:

| | | |
|---|---|---|
| Solids content | 39.0% | |
| pH | 8.58 | |
| Viscosity @ 23° C. | 1850 | mPas |
| Particle size | 44 | nm |

### Example 11 (comparative)

The procedure described in Example 7 was repeated, except that hydroxypivalic acid was used instead of the monoamide of the invention. The dispersion possessed the following properties:

| | | |
|---|---|---|
| Solids content | 30.0% | |
| pH | 9.06 | |
| Viscosity @ 23° C. | 4400 | mPas |
| Particle size | 39 | nm |

### Examples 12-17 (Performance tests)

Clear coat compositions were prepared from the following components. The clear coat compositions were used to produce films which were dried at room temperature for 10 minutes and then baked at 165° C. for 30 minutes. The films obtained were subjected to a performance assessment. The results are set forth in the table below.

Amounts in parts by weight

| | Example No. | | | | | |
|---|---|---|---|---|---|---|
| | 12 | 13 | 14 | 15 | 16 | 17 |
| Polyisocyanate from Example | 4 | 7 | 8 | 9 | 10 | 11-Comp |
| Amount of polyisocyanate | 91.1 | 91.1 | 91.1 | 70.6 | 64.3 | 100.4 |
| Desmophen ® D 270 | 50.0 | 50.0 | 50.0 | 50.0 | 50.0 | 50.0 |
| Additol XW 395 | 1.1 | 1.1 | 1.1 | 1.1 | 1.1 | 1.1 |
| Surfynol 104 | 1.1 | 1.1 | 1.1 | 1.1 | 1.1 | 1.1 |
| Distilled water | 66.3 | 60.0 | 72.0 | 55.0 | 62.0 | 65.0 |
| Baking conditions | 10′RT + | 10′RT + | 10′RT + | 10′RT + | 10′RT + | 10′RT + |
| | 20′165° C. | 20′165° C. | 20′165° C. | 20′165° C. | 20′165° C. | 20′165° C. |
| Salt spray test 144 h; | 0 | 16 | 8 | 28 | 27 | 20 |
| sub-film migration in mm | | | | | | |
| Solvent resistance ^{[1]} | 1/2/4/4 | 2/3/4/4 | 2/2/4/4 | 2/3/4/4 | 2/3/4/4 | 2/3/4/4 |

Solvent resistance: exposure time 1 minute, sequence of the solvents as follows: xylene/methoxypropyl acetate/ethyl acetate/acetone. Evaluation: 0 (very good) to 5 (poor).

For the salt spray test the coating materials were sprayed onto steel panels using a gravity-fed cup-type gun, and baked. The salt spray test took place in accordance with DIN 53 167.

In the performance tests the coating from Example 12 had better solvent resistance than the coating from Comparative Example 17. For Examples 12, 13 and 14 the sub-film migration in the salt spray test was relatively low, indicating superior adhesion and corrosion resistance.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A silicon-free polyisocyanate or polyurethane which contains at least one structural unit of formula (1), 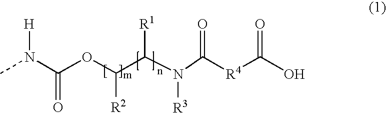
wherein
m is0to8,
n is 0 to 8,
m+n is≧2,
R¹ and R² independently of one another are each hydrogen or an OH-free, C₁ to C₈ alkyl or cycloalkyl radical,
R⁴ is the radical obtained by removing the carboxylic acid groups from a difunctional aliphatic dicarboxylic acid having at least two carbon atoms, a cycloaliphatic dicarboxylic acid having at least 6 carbon atoms or an aromatic dicarboxylic acid having at least 6 carbon atoms, and
R³ is the same as R¹ or R² or corresponds to formula (2) 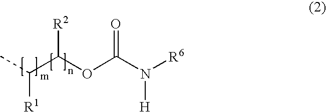
wherein
R¹ and R² are as defined above and
R⁶ is an alkyl or aryl radical obtained by removing an isocyanate group from a di- or polyisocyanate having optionally blocked NCO groups.

2. The silicon-free polyisocyanate or polyurethane of claim I wherein R³ is the same as R¹ or R².

3. A process for preparing the silicon-free polyisocyanate or polyurethane of claim 1 which comprises reacting
A) a polyisocyanate with
B) a monoamide of formula (3) 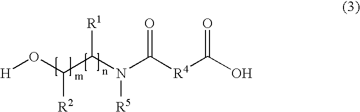
wherein
m is 0to 8,
n is 0to 8,
m+n is≧2,
R¹ and R² independently of one another are each hydrogen or an OH-free, C₁ to C₈ alkyl or cycloalkyl radical,
R⁴ is the radical obtained by removing the carboxylic acid groups from a difunctional aliphatic dicarboxylic acid having at least two carbon atoms, a cycloaliphatic dicarboxylic acid having at least 6 carbon atoms or an aromatic dicarboxylic acid having at least 6 carbon atoms, and
R⁵ is the same as R¹ or R² or corresponds to formula (6) 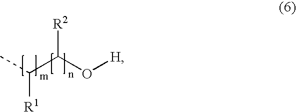
C) a polyol and
D) optionally another compound containing isocyanate-reactive groups.

4. The process of claim 3 wherein R⁵ is the same as R¹ or R² and the monoamide of formula (3) is monohydroxy-functional.

5. The process of claim 3 wherein the monoamide of formula (3) comprises the reaction product formed by an equimolar reaction of i) a monohydroxy-functional amine comprising N-methylethanolamine, N-methylisopropanolamine or 1-aminopropanol and ii) an acid anhydride comprising phthalic, trimellitic or hexahydrophthalic anhydride.

6. The process of claim 3 wherein polyisocyanate A) comprises a polyisocyanate adduct containing biuret, isocyanurate and/or uretdione groups and prepared from hexamethylene diisocyanate and/or isophorone diisocyanate.

7. The process of claim 4 wherein polyisocyanate A) comprises a polyisocyanate adduct containing biuret, isocyanurate and/or uretdione groups and prepared from hexamethylene diisocyanate and/or isophorone diisocyanate.

8. The process of claim 5 wherein polyisocyanate A) comprises a polyisocyanate adduct containing biuret, isocyanurate and/or uretdione groups and prepared from hexamethylene diisocyanate and/or isophorone diisocyanate.

9. The process of claim 3 wherein polyol C) comprises a polyester, polyesteramide, polyurethane, polyacrylate, polycarbonate, polyacetal or polyether polyol having a number average molecular weight of 800 to 5000 g/mol.

10. The process of claim 4 wherein polyol C) comprises a polyester, polyesteramide, polyurethane, polyacrylate, polycarbonate, polyacetal or polyether polyol having a number average molecular weight of 800 to 5000 g/mol.

11. The process of claim 5 wherein polyol C) comprises a polyester, polyesteramide, polyurethane, polyacrylate, polycarbonate, polyacetal or polyether polyol having a number average molecular weight of 800 to 5000 g/mol.

12. The process of claim 6 wherein polyol C) comprises a polyester, polyesteramide, polyurethane, polyacrylate, polycarbonate, polyacetal or polyether polyol having a number average molecular weight of 800 to 5000 g/mol.

13. The process of claim 7 wherein polyol C) comprises a polyester, polyesteramide, polyurethane, polyacrylate, polycarbonate, polyacetal or polyether polyol having a number average molecular weight of 800 to 5000 g/mol.

14. The process of claim 8 wherein polyol C) comprises a polyester, polyesteramide, polyurethane, polyacrylate, polycarbonate, polyacetal or polyether polyol having a number average molecular weight of 800 to 5000 g/mol.

15. The process of claim 3 wherein the which comprises carrying out the process in the presence of a catalyst and/or a solvent.

16. The process of claim 3 wherein component D) comprises a blocking agent for isocyanate groups and/or an isocyanate-reactive hydrophilic agent.

17. The process of claim 4 wherein component D) comprises a blocking agent for isocyanate groups and/or an isocyanate-reactive hydrophilic agent.

18. The process of claim 5 wherein component D) comprises a blocking agent for isocyanate groups and/or an isocyanate-reactive hydrophilic agent.

19. An aqueous dispersion comprising the silicon-free polyisocyanate or polyurethane of claim 1.

20. An aqueous coating, adhesive or sealant composition comprising the silicon-free polyisocyanate or polyurethane of claim 1.
